(19) United States
(12) Patent Application Publication
(10) Pub. No.: US 2007/0254255 A1
(43) Pub. Date: Nov. 1, 2007

(54) System, apparatus and methods for board cooling

(76) Inventors: James E. Neville, Springfield, NJ (US); Yushing Erin Sun, Millington, NJ (US)

Correspondence Address: Carol H. Peters;Mintz, Levin, Cohn, Ferris,, Glovsky and Popeo, P.C., One Financial Center, Boston, MA, 02111, US

(21) Appl. No.: 11/729,321

(22) Filed: Mar. 27, 2007

Related U.S. Application Data
(60) Provisional application No. 60/786,940, filed on Mar. 28, 2006.

(51) Int. Cl. F27B 9/00; B05B 1/14

(52) U.S. Cl. 432/121; 239/550

(57) ABSTRACT

Cooling of printed circuit boards and electronic components mounted to such boards through evaporative cooling is achieved using a system, an apparatus and methods of water mist rapid cooling. The system and the apparatus comprise one or more spray assemblies, each including a water distribution manifold assembly and a multiple of spray nozzles connected to the manifold assembly, to deliver water spray mists to printed circuit boards during reflow processing. Spray assemblies are incorporated in a reflow oven to define an evaporative cooling zone. As heated printed circuit boards are conveyed through an evaporative cooling zone, one or more spray assemblies spray boards with water spray mists to lower elevated temperatures of boards, components, and solders to thereby ensure solder solidification to form solder joints and interconnections and sufficient board cooling for safe handling. The system, apparatus and methods are particularly suited for high temperature reflow soldering, such as reflow processes using lead-free solders.

### CLAIM OF PRIORITY TO PRIOR APPLICATION

This application claims priority to U.S. provisional patent application No. 60/786,940, filed Mar. 28, 2006, the disclosure of which is incorporated herein in its entirety by reference.

### FIELD OF THE INVENTION

The invention relates to a system and an apparatus used in surface mount technology (SMT) for cooling a printed circuit board (PCB) and electronic components mounted to the PCB. More particularly, the invention provides an evaporative cooling system and apparatus for use in a reflow oven that applies water mist to a PCB for cooling the PCB and its components by evaporative cooling.

### BACKGROUND OF THE INVENTION

Reflow ovens have been utilized in the SMT industry for many years. In the manufacturing of a printed circuit board (PCB) assembly, a PCB has deposited on its surface dots of solder paste which typically is a combination of solder and a flux material. After the solder paste has been deposited on the PCB, the PCB is forwarded to a “pick-and-place” machine, which “places” electronic components, including integrated circuits and other devices, onto the PCB. The contacts along the bottom sides of the components thereby contact the previously deposited solder paste dots. At this point, the solder paste is a viscous toothpaste-like material which cannot itself yet hold the components to the PCB. Thus, in order to make permanent the connection between the components and the board, the PCB is fed through a reflow oven, which has hereto been and continues to be an elongated furnace or oven with means configured for conveying or moving the PCB through an interior tunnel of the oven. The reflow oven can contain a number of heating zones including heaters which heat up the solder paste, the board and the components so that the solder paste melts. After the solder paste has melted, the reflow oven can convey the board to a cooling zone which cools the board, the components and the solder paste to help to form permanent bonds, referred to as solder joints, between the board and the components.

The use of hazardous materials contained in electronic components and on PCBs has become a growing environmental concern. Hazardous materials, such as lead, are presently components in many solder paste formulations used to join electronic components to PCBs. One of the most popular solder paste formulations is a combination of tin and lead. Tin-lead solder alloys have been known for hundreds, if not thousands, of years, but only until relatively recently have major efforts been made to ban the use of lead in such solder formulations. A recent ban is the European Directive referred to as the Regulation of Hazardous Materials (RoHS) which became effective in the European Union in July 2006. RoHS bans, among other hazardous materials, certain concentrations of lead in electronic assemblies and equipment. In the United States, several states are considering hazardous materials restrictions and bans, and, in particular, California has enacted a limited ban of the same hazardous materials limited under RoHS.

Thus, electronics manufacturers are required to eliminate lead in typical solder alloys. Many of the new lead-free solder formulations generally require higher melting temperatures for surface mount applications than the tin-lead solder formulations. Whereas tin-lead solders typically melt at about 183° C., many of the available lead-free solders melt at temperatures higher than 215° C. The practical implications of switching to lead-free solder alloys would affect the structure and the design of conventional reflow ovens.

In present reflow ovens utilized for soldering with tin-lead solders, it has been sufficient, after the PCB and components have been heated to melt the solder, to convey the board through a cooling zone that uses cool air to lower board and component temperatures and to thereby cause solder to solidify to form a solder joint and the board to cool sufficiently for handling. However, with the increased temperatures required for soldering with lead-free solders, merely using cool air to cool a board and its components, and, in particular, large components, and/or to cause solder to solidify, has been found to be insufficient with respect to solder joint formation.

### SUMMARY OF THE INVENTION

The present invention addresses the foregoing issues related to use of lead-free solders and includes a system and an apparatus for rapidly cooling PCBs and electronic components mounted to the PCBs as the PCBs exit heating zone(s) of a reflow oven.

Cooling PCBs and electronic components mounted thereon is accomplished through use of evaporative cooling that is implemented with a rapid cooling water mist system and apparatus according to the invention. The water mist cooling apparatus is located within an interior of a reflow oven, e.g., along a conveying path of the reflow oven between the end or exit of one or more heating zones and the beginning or entrance to one or more cooling zones. It has been found that spraying PCBs and components with a fine mist of water, e.g., pressurized and/or atomized water, achieves rapid cooling of the PCBs and components by evaporative cooling. Evaporative cooling lowers elevated temperatures of boards, components, and solders that are required and are experienced during reflow processing with lead-free solder formulations. Where large scale components, such as, for instance, ceramic ball grid array devices (BGAs), large socket connectors and other connections that have a large mass and therefore have a large initial thermal mass, are formed on PCBs, the requirements for rapid cooling are exacerbated with use of lead-free solders. Evaporative cooling of such boards and components using the system and the apparatus according to the invention helps to alleviate or to eliminate many cooling problems.

In an aspect, the invention provides a system for cooling printed circuit boards during a reflow soldering process performed in a reflow oven comprising a water mist cooling apparatus including a water distribution manifold assembly and at least one spray nozzle including a first inlet connected to the manifold and a nozzle outlet configured and angled to delivery atomized water to the printed circuit boards.

Implementations of the invention may include one or more of the following capabilities. The at least one spray nozzle is angled to direct atomized water at the printed circuit boards as the boards exit a heating zone of the reflow oven. The atomized water cools the printed circuit boards through at least evaporative cooling. The system further comprises at least one sensor device disposed and configured to sense entrance and movement of the printed circuit boards into and through the reflow oven. The system also comprises at least one processor operatively coupled to the at least one sensor device and configured to sense the printed circuit boards entering the reflow oven and to implement a delay timer as a function of a speed of the printed circuit boards to control an actuation time and a deactuation time of the at least one spray nozzle. The at least one processor is further configured to control the at least one spray nozzle as a function of at least one of a size of the printed circuit boards entering the reflow oven and a location of one or more components on the printed circuit boards. The at least one processor is further configured to control the at least one spray nozzle as a function of a temperature of a heating zone of the reflow oven. The system is further configured for use during a reflow lead-free soldering process. The system further comprises a second inlet connected to the at least one spray nozzle, the second inlet being configured for connection to a pressurized gas supply and being further configured to deliver gas to the at least one nozzle, wherein gas supplied to the at least one nozzle atomizes water at the nozzle outlet.

In another aspect, the invention provides a reflow oven for reflow soldering surface mount electronic components to printed circuit boards, the reflow oven comprising conveying means for conveying printed circuit boards through one or more zones of the reflow oven, a heating zone, a cooling zone, and an evaporative cooling zone located between the heating zone and the cooling zone, the evaporative cooling zone comprising a water distribution manifold assembly, at least one spray nozzle including a first inlet connected to the manifold and a spray outlet configured and angled to delivery atomized water to the printed circuit boards.

Implementations of the invention may include one or more of the following features. At least one spray nozzle of the evaporative cooling zone of the reflow oven is angled to aim atomized water at the printed circuit boards as the boards exit the heating zone. The atomized spray cools the printed circuit boards through at least evaporative cooling. The reflow oven further comprises at least one sensor device configured to sense the printed circuit boards as the boards enter the reflow oven. The reflow oven further comprises at least one processor coupled to the at least one sensor device and configured to sense the printed circuit boards as the boards enter the reflow oven and to implement a delay timer as a function of a speed of conveying means conveying the printed circuit boards through the reflow oven to control an actuation time and a deactuation time of the at least one spray nozzle. The at least one processor is further configured to control the at least one spray nozzle as a function of at least one of a size of the printed circuit boards entering the reflow oven and a location of one or more components on the printed circuit boards. The at least one processor is further configured to control the at least one spray nozzle as a function of a temperature of the heating zone of the reflow oven. The water distribution manifold assembly further comprises an inlet water connection configured to receive at least one of water and pressurized water. The water mist cooling apparatus further comprises a water pressure regulator with an inlet connected to the inlet water connection and an outlet coupled to the water distribution manifold assembly. The reflow oven further comprises a water holding tank and a water pump disposed and configured to receive water from the water tank and to supply pressurized water to the water distribution manifold assembly. The reflow oven further comprises a second inlet connected to the at least one spray nozzle, the second inlet being configured for connection to a pressurized gas supply and being further configured to deliver gas to the at least one nozzle, wherein gas supplied to the at least one nozzle atomizes water at the nozzle outlet.

In another aspect, the invention provides a reflow oven for reflow soldering surface mount electronic components to printed circuit boards, the reflow oven comprising conveying means for conveying printed circuit boards through one or more zones of the reflow oven, a heating zone, a cooling zone, and cooling means for rapidly cooling the printed circuit boards through evaporative cooling after the printed circuit boards exit the heating zone and before the printed circuit boards enter the cooling zone.

In a further aspect, the invention provides a method of cooling a printed circuit board during a reflow soldering process, the method comprising sensing the printed circuit board entering the reflow oven; conveying the printed circuit board through a heating zone; exhausting heated air from the reflow oven; spraying atomized water to contact the heated printed circuit board at an appropriate time determined as a function of sensing at least one of the printed circuit board entering the reflow oven and the printed circuit board exiting a heating zone; and blowing air onto the printed circuit board.

Implementations of the invention provide one or more of the following features. The spraying atomized water includes spraying atomized water to contact the printed circuit board subsequent to heating the printed circuit board and before blowing air onto the printed circuit board. The spraying atomized water cools the printed circuit board through at least evaporative cooling. The method is further configured for cooling a printed circuit board during a lead-free soldering reflow process.

Various aspects of the invention may provide one or more of the following capabilities. A reflow oven with an integrated evaporative cooling system or apparatus may be provided. Such a system and apparatus may include a water mist cooling apparatus configured for applying cooling water mist, e.g., of pressurized and/or atomized water, to surfaces of heated printed circuit boards and surface mount components to achieve cooling of the boards and components by evaporative cooling. More rapid cooling of printed circuit boards and surface mount components undergoing lead-free reflow soldering may be achieved. Existing reflow ovens may be retrofitted with an integrated evaporative cooling system or apparatus to enable such reflow ovens to meet the cooling requirements of lead-free soldering.

An evaporative cooling system and apparatus of a reflow oven may include one or more indicator sensor devices for detecting printed circuit boards being conveyed within the reflow oven, and for actuating/de-actuating the evaporative cooling system and apparatus. Indicator sensor devices may enable actuation/deactuation of the evaporative cooling system and apparatus as a function of a speed of conveyance of the boards. In addition, actuation/deactuation of the evaporative cooling system and apparatus may be enabled as a function of a size of individual printed circuit boards being conveyed through a reflow oven, a size and/or location of one or more components disposed on along printed circuit boards, temperatures of boards, temperatures of one or more heating zones of a reflow oven, and/or other variables of a reflow soldering process, including a lead-free reflow soldering process.

The evaporative cooling system and apparatus may accommodate adjustments of the pressures of water and/or of gas that may be supplied to the evaporative cooling apparatus. In addition, the evaporative cooling system and apparatus may accommodate adjustments of the flow of water to the evaporative cooling apparatus, to thereby permit adjustment and control of pressurized and/or atomized water spray mist the apparatus may deliver.

These and other capabilities of the invention, along with the invention itself, will be more fully understood after a review of the following figures, detailed description, and claims.

### BRIEF DESCRIPTION OF THE FIGURES

FIG. 1 is a schematic side view of a reflow oven including an integrated evaporative cooling system;

FIG. 2 is a schematic top view of an air cooling zone and an evaporative cooling zone including spray assemblies of a spray apparatus; and

FIG. 3 is a perspective view of a water manifold assembly and water nozzles of one of the spray assemblies shown in FIG. 2.

### DETAILED DESCRIPTION OF PREFERRED EMBODIMENTS

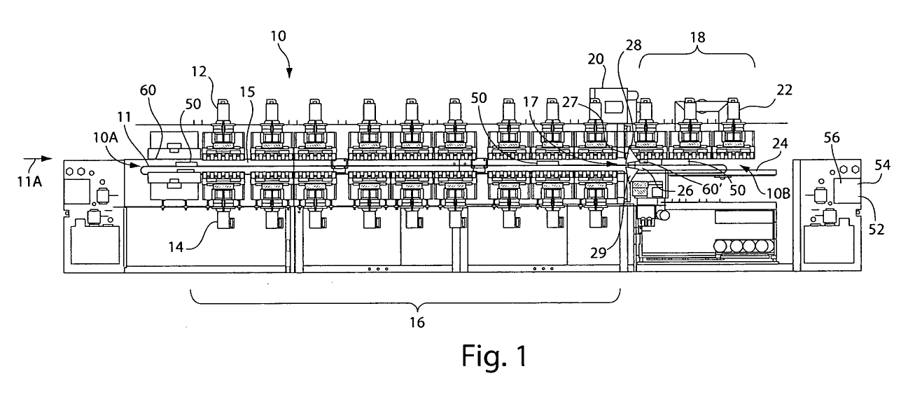

Referring to FIG. 1, in an aspect, the invention provides a reflow oven 10 including an integrated water mist rapid cooling system 26. The reflow oven 10 can include a reflow oven such as the Model No. 1900 oven manufactured by Heller Industries of Florham Park, N.J. The reflow oven 10 includes a heating zone 16 and a cooling zone 18 configured within an interior of the oven 10. The heating zone 16 can include a number of individual zones and/or heaters 12 and 14 positioned above and/or below, respectively, of an open area or a tunnel 15 defined within the interior of the reflow oven 10 and through which printed circuit boards and/or other substrates are conveyed for processing. As shown in FIG. 1, the tunnel 15 is defined between the upper and the lower heaters 12 and 14. A conveyor means 11 is disposed within the oven 10 and along the tunnel 15 and is configured to transport PCBs along the tunnel 15 from one end to another end of the oven. 10. In a preferred embodiment of the invention, such conveyor means 11 includes, but is not limited to, a continuous conveyor chain or belt that extends through the oven 10, e.g., from an entrance 10A of the tunnel 15 to an exit 10B of the tunnel 15, and is configured to transport PCBs through the oven 10 in a direction shown by arrow 11A in FIG. 1. During operation of the oven 10, a PCB is placed on the conveyor means 11 and is conveyed along the tunnel 15 between the heaters 12 and 14 of the heating zone 16. At an end of the heating zone 16 and before the cooling zone 18, an exhaust station 20 is positioned. The exhaust station 20 is configured to extract heat out of the oven 10 and to exhaust heat to an outside area, or to a conventional re-cooling device, if the exhaust air extracted is to be re-circulated in a conventional manner.

Prior to the present invention, a PCB would exit the heating zone 16 and immediately enter the cooling zone 18 in which one or more cooling fans 22 would blow cooled air or ambient air onto the surfaces of the PCB in order to cool the PCB to enable the solder to cool and to thereby solidify, and to lower the temperature of the PCB sufficiently to permit safe handling as the PCB exits the reflow oven 10 and is delivered at position 24.

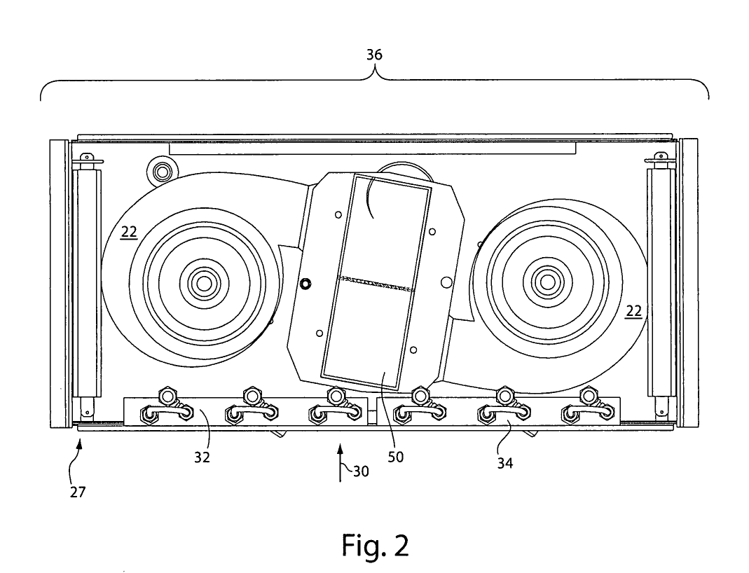

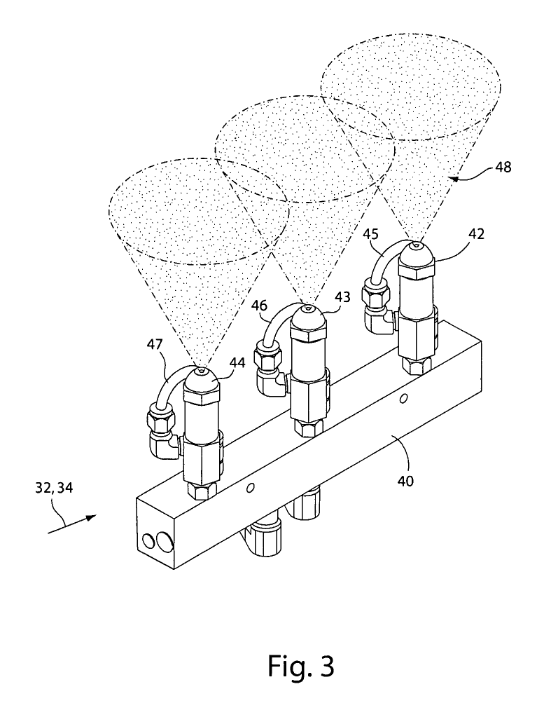

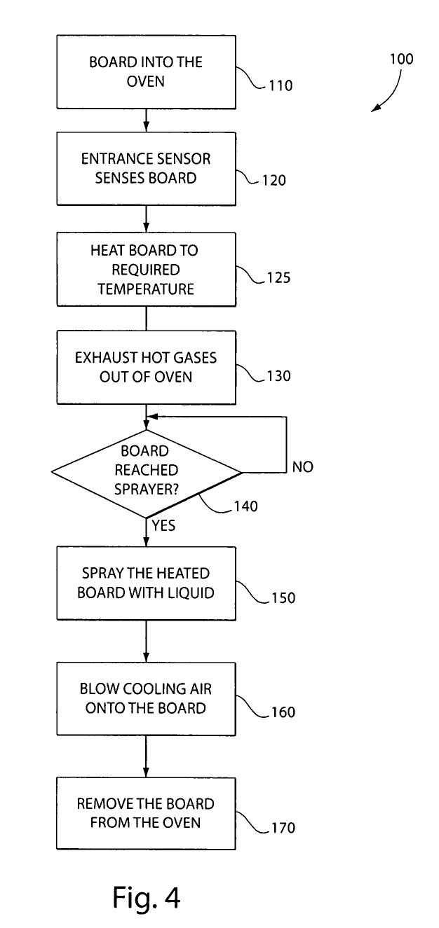

With further reference to FIG. 1, in the preferred embodiment of the invention, the integrated water mist rapid cooling system 26 is inserted at a position between the heating zone 16 and the cooling zone 18 and is positioned immediately after the exhaust station 20. A water mist cooling apparatus 27 of the system 26 is shown in FIGS. 2 and 3.

Referring to FIGS. 2 and 3, the water mist rapid cooling apparatus 27 is illustrated. A PCB 50 being conveyed through the oven tunnel 15 moves in direction 30, as shown in FIG. 2, and may span an area less than a width 36 of the tunnel 15. Spray assemblies 32 and 34 of the apparatus 27 each include a water distribution manifold assembly 40 and a multiple of water spray mist nozzles 42, 43, and 44 each connected to the manifold assembly 40. It will be appreciated that while the apparatus 27 includes two spray assemblies 32 and 34 and each spray assembly 32 and 34 includes a single manifold assembly 40 with three spray nozzles 42, 43, and 44, any number of assemblies 32 and 34, manifolds 40, and/or nozzles 42, 43, and 44 may be incorporated within the reflow oven 10 to achieve evaporative cooling.

With further reference to FIG. 2, the apparatus 27 illustrated includes an embodiment of the invention whereby the assemblies 32 and 34 and the water spray mist nozzles 42, 43, and 44 are positioned along a top of or relatively above the tunnel 15, e.g., above the conveyor means 11, of the reflow oven 10, as shown at position 28 in FIG. 1, and are oriented to direct water mist in a downward orientation toward the PCBs being conveyed through the tunnel 15. Alternatively, or additionally, the embodiment may include the assemblies 32 and 34 and the spray nozzles 42, 43, and 44 positioned along a bottom of or relatively below the tunnel 15, e.g., the conveyor means 11, the tunnel 15, as shown at position 29 in FIG. 1 and are oriented to direct water mist in an upward orientation toward the PCBs being conveyed through the tunnel 15.

With further reference to FIG. 3, details of a spray assembly 32 and 34 and a water distribution manifold assembly 40 of the apparatus 27 are illustrated. The water distribution manifold assembly 40 is configured to receive water supplied from an external source or reservoir, e.g., via one or more inlets. If a reservoir is incorporated with the system 26, such reservoir may include a water tank operatively connected to the water mist rapid cooling apparatus 27. The embodiment of the invention including a water tank may also include a water pump to pressurize water before water is supplied to each spray assembly 32 and 34 via the assembly manifold 40. It has been found that a build-up of minerals along and within the nozzles 42, 43 and 44 may occur through operation of the system 26 and can impede the operation of the apparatus 27. Therefore, deionized water is preferably utilized with the apparatus 27. Water may be supplied under pressure to each water manifold assembly 40 and thereafter to the nozzles 42, 43, and 44 such that the nozzles 42, 43, and 44 spray water as a pressurized and/or atomized spray mist 48. Flow rates of one or more water input supplies to the manifold assembly 40 may be adjusted and/or regulated using one or more water flow regulators.

Additionally, each nozzle 42, 43, and 44 may include an inlet 45, 46, and 47, respectively, that supplies pressurized air, or pressurized nitrogen for use in an “inerted” oven 10, as is conventionally known in the industry, to each nozzle 42, 43 and 44 to help to pressurize water delivered to the nozzles 42, 43, and 44 and to thereby help to deliver as a pressurized and/or atomized spray mist 48.

Further, as mentioned, water input supplies, as well as air input supplies and/or gas input supplies, may be increased, decreased and/or eliminated, as is required and/or as desired to achieve water flow rates, spray rates, pressurized and/or atomized spray mists, and/or spray patterns, as described below, to help to adjust the spray mists the spray assemblies 32 and 34 produce.

Pressures of water and/or pressures of air that may be introduced into the nozzles 42, 43, and 44 help the nozzles 42, 43, and 44 to produce water mist 48 in a spray pattern, such as the spray pattern configured as a spray mist cone 48 illustrated in FIG. 2. Those of ordinary skill in the art will appreciate that other types and shapes of nozzles 42, 43, and 44 may be used, e.g., to produce different types of spray patterns, and that the pressure.

Referring further to FIG. 2, and in connection with the spray assemblies 32 and 34, there exists suitable means known in the art that may be implemented with the apparatus 27 and the system 26 to turn on or off, or to actuate/de-actuate, individual and/or groups of the nozzles 42, 43, and 44 of each assembly 32 and 34. Such structures, devices and/or means may be implemented for any of a number of reasons, e.g., relating to achieving rapid board cooling, and may include manual and/or automatic actuation devices disposed locally and/or remotely relative to the assemblies 32 and 34 to thereby incorporate such devices with the assemblies 32 and 34 and to thereby configure the system 26.

First, depending on a width of a board 50 being conveyed through the tunnel 15, use of all three spray nozzles 42, 43, and 44 of each assembly 32 and 34, for a total of six nozzles, may not be necessary, while half or fewer nozzles 42, 43, and 44 of each assembly 32 and 34 may be operative to accommodate smaller PCBs 50, e.g., having narrower widths, as such small PCBs 50 are being conveyed through the oven 10. In addition, the invention envisions that the nozzles 42, 43, and 44 can be individually controlled, e.g., manually and/or electrically actuated, so that PCBs 50 can be selectively sprayed by the assemblies 32 and 34 as the PCBs 50 proceed through the oven 10 in accordance with a size and/or a width of the boards, and/or a size and/or a location of one or more components disposed along the boards, and/or in accordance with the requirements and/or desires of the operator. For instance, if a particularly large component is located along one edge of a board 50, nozzles 42, 43, and 44 located at a position, and on an assembly 32 and 34, to intersect that component as the board 50 proceeds through the evaporative cooling zone 17 may be selectively actuated to delivery spray mist, while the other nozzles 42, 43, and 44 and/or assemblies 32 and 34 remain inactive or de-actuated.

As described above, spray assemblies 32 and 34 may be positioned at a location 29 along a bottom of or relatively below, e.g., the conveying means 11, the tunnel 15 as well as at a location 28 along a top of or relatively below, e.g., the conveying means 11, the tunnel 15 with the top assemblies 32 and 34 and nozzles 42, 43, and 44 spraying water mist in an downward orientation relative to the tunnel 15 and toward the PCBS and the bottom assemblies 32 and 34 and nozzles 32, 43, and 44 spraying water mist in an upward orientation relative to the tunnel 15 and toward the PCBs. Thus, a number of combinations of the assemblies 32 and 34 and the nozzles 42, 43, and 44 may be utilized for evaporative cooling, depending on the board, e.g., one or more board dimensions, size of board components, location of board components, reflow temperatures, temperatures of heating zone(s), and any other characteristics associated with a reflow soldering process. For instance, the top assemblies 32 and 34 and the nozzles 42, 43, and 44 located at a position 28 relatively above the tunnel 15 alone may be utilized or the bottom assemblies and the nozzles 42, 43, and 44 located at a position 29 relatively below the tunnel 15 alone may be utilized. In addition, both the top and bottom assemblies 32 and 34 may be utilized simultaneously to spray water mist towards, e.g., both sides of, the boards being conveyed through the tunnel 15. As described above, only one spray assembly 32 and 34 including the three spray nozzles 42, 43, and 44 may be utilized and thereby the system 26 enables that one or more of the top assemblies 32 and 34 and/or one or more of the bottom assemblies 32 and 34 may be selectively operated for evaporation cooling. Those of ordinary skill in the art will appreciate that other liquids in addition to or as an alternative to water may be utilized for evaporative cooling purposes.

It is desirable that spraying of water by the assemblies 32 and 34 of the apparatus 27 be confined to the time that a board 50 is positioned and/or is being conveyed within the evaporative cooling zone 17, e.g., an area above and/or below one or more spray assemblies 32 and 34, and/or is otherwise proximate to the zone 17, in order to help to conserve water and to help to prevent excess moisture from forming within the oven 10. In addition to purposes of conserving water and preventing excess moisture, restricting spraying of the assemblies 32 and 34 when a board is positioned and/or is being conveyed within the evaporative cooling zone 17, and/or is otherwise proximate to the zone 17, helps to adjust or fine tune the time the assemblies 32 and 34 produce spray mist and/or the spray mist the assemblies 32 and 34 deliver to a board 50.

One way of accomplishing conservation, and/or such adjustments and fine tuning, in the terms noted is to use one or more known sensor devices 60, such as one or more photoelectric or other general sensor devices manufactured by SUNX of Kasugai, Aichi, Japan, that detect boards being conveyed through the oven 10, e.g., entering the oven 10 at the entrance 10A. Because the speed of a board 50 is known from the speed of the conveyor means 11, the time the board will arrive in, or proximate to, the evaporative cooling zone 17 may be calculated using the outputs from the one or more sensor devices 60 and certain known calculations. In addition, one or more known sensor devices 60′ may be incorporated with the oven 10 to detect boards exiting the evaporative cooling zone 17. Evaporative cooling by the apparatus 27 may be started when a board 50 arrives at, or proximate to, the evaporative cooling zone 17 and may be stopped when the board exits the evaporative cooling zone 17 and enters into the cooling zone 18, as shown in FIG. 1. Control of the timing of the spray misting with the assemblies 32 and 34 may also depend on one or more temperatures within the oven 10, e.g., within the heating zone 16. It has been found to begin spray misting with the assemblies 32 and 34 just before a board 50 arrives at the evaporative cooling zone 17 and to shut spray misting off just when the board 50 leaves the evaporative cooling zone 17 works well to help to insure rapid cooling of the board 50 and any surface mounted components to thereby help to achieve sufficient cooling of the board 50, components and/or solder. Excess water mist may be exhausted by the reflow oven 10 through use of the exhaust manifold 20.

In operation, the reflow oven 10 conveys a PCB 50 loaded on the conveyor means 11 through the heating zone 16 that typically operates in a range of temperatures from about 240° C. to about 280° C., which includes a typical range of temperatures for reflowing lead-free solder formulations. The invention however is not limited to high temperature reflow ovens and may be incorporated with and/or utilized in other reflow ovens that may operate at ranges of lower temperatures. In addition, the invention is not limited to high-temperature lead-free solder formulations and may be used in applications and/or in reflow ovens utilizing low temperature solder formulations, including low temperature lead-free solder formulations.

The temperature of a PCB 50 entering the evaporative cooling zone 17 will generally have a range of temperatures from approximately 225° C., for eutectic solders, to approximately 250° C., for lead-free solders. While temperatures of water used for evaporative cooling are preferably about room temperature, water may, of course, be cooled or even heated for special occasions or purposes. In the embodiment shown in FIG. 1, the conveyor means 11 is not slowed down while a board 50 is being conveyed through the evaporative cooling zone 17. However, if desired, the speed of the conveyor means 11 may be altered to thereby either increase or decrease the conveyance speed of a board through the evaporative cooling zone 17. Also, if desired, the conveyor means 11 may be split in a conventional manner and the speed of a board 50 through the evaporative cooling zone 17 may be changed either to increase or decrease the speed, as may be required and/or desired.

It has been found that with the apparatus 27 of the invention shown in FIGS. 1-3, the evaporative cooling zone 17 is able to cool solder joints on a PCB 50 at a cooling rate of greater than about 3° C. per second for a range of temperatures from about 227° C. to about 200° C., which corresponds to the solidus temperatures of many lead-free solders. The cooling rate of about 3° C. per second is desirable because it has been found that such cooling rate helps to improve solder joint strength and helps to improve solder joint durability.

Many modifications may be made to the system 26 and the apparatus 27 described above. For instance, the spray nozzles 42, 43, and 44 of the water manifold assembly 40 may be designed and/or may be disposed at an angle relative to one direction or another in order to help the nozzles 42, 43, and 44 to spray water or other liquid mist at an angle. The angled nozzles 42, 43, and 44 thereby help to confine spray mist to the evaporative cooling zone 17 and to help to ensure that spray does not enter into either the heating zone 16 and/or the cooling zone 18.

In addition, the system 26 may be equipped with an inlet water pressure regulator 52 and/or an inlet gas pressure regulator 54 to allow adjustments of water pressures and air pressures, respectively, to the apparatus 27 to permit an operator to fine tune the performance of the apparatus 27 to thereby fine tune evaporative cooling. Also, the rate of cooling may be adjusted by adjusting and/or controlling the rate of flow of water or other fluid, e.g., using a flow rate regulator, in and through the spray nozzles 42, 43, and 44.

It has been unexpectedly found that the water cooling mist assists in what is termed “inerting” the reflow oven 10. In certain reflow applications, it is desirable that no oxygen be present in the tunnel 15 during reflow processing so that oxidation of the solder joints is minimized. Many conventional reflow ovens utilize a nitrogen atmosphere by which nitrogen gas is flowed into the oven tunnel 15 to prevent such oxidation. It has been found that in ovens 10 incorporating the system 26 or the apparatus 27 according to the invention for spraying water mist for board cooling helps to displace oxygen in the evaporative cooling zone 17 and thereby helps to reduce the amount of oxygen in the zone 17. The evaporative cooling zone 17, at least, may not require a nitrogen inlet for delivery of nitrogen gas into the zone 17 due to the “self-inerting” function the system 26 and/or the apparatus 27 achieves.

In another aspect, with further reference to FIG. 1, the invention may include a controller or processor 56 operatively coupled to the apparatus 27 and located either locally or remotely relative to the reflow oven 10 to thereby integrate the apparatus 27 into the evaporative cooling system 26. The controller or processor 56 may be operatively coupled with the one or more sensor devices 60 and 60′ described above to detect the PCB 50 as it enters the oven 10, and, optionally, as the PCB 50 exits the zone 17. The controller or processor 56 may be configured to determine and to control the speed of the conveyor means 11 and thereby the speed of a PCB 50 moving through the oven 10. In addition, the controller or processor 56, alone or where operatively coupled to one or more of the sensor devices 60 and 60′, may be used to actuate/deactuate the water mist cooling apparatus 27, as described above, as a function of a speed of the printed circuit board 50 and/or as a function of one or more other variables, e.g., the location of the printed circuit board 50 in the oven 10 and/or relative to the evaporative cooling zone 17, a size of the printed circuit board 50, a size and/or location of one or more components on the board 50, temperatures of the board 50, temperatures of the heating zone 16, and/or other characteristics of the reflow process. The controller or processor 56 may incorporate a delay timer to affect such actuation/deactuation of the apparatus 27 as a function of any of the variables noted above. Further, the controller or processor 56 may be used to actuate or control the inlet water pressure regulator 52 and/or the inlet gas pressure regulator 54 to allow adjustments of water pressures and air pressures, respectively, to the apparatus 27 to permit an operator to fine tune the performance of the apparatus 27 and to enable any efforts for conserving water and/or energy which the system 26 and the reflow oven 10 consumes during operation. The controller or processor 56 may also be used to actuate or control the rate of flow of water or other fluid in and through the apparatus 27, as described above.

In operation, referring to FIG. 4, with further reference to FIGS. 1 and 3, a process 100 for reflow soldering and for cooling printed circuit boards 50 using the system 26 and the apparatus 27 of the invention includes the stages shown. The process 100, however, is exemplary only and not limiting. The process 100 may be altered, e.g., by having stages added, removed, or rearranged.

At stage 110, a printed circuit board 50 is conveyed by the conveyor means 11 into the reflow oven 10, e.g. through the entrance 10A of the tunnel 15. The board 50 has deposited along one or both of its surfaces a solder alloy paste, e.g., a lead-free solder alloy paste, and one or more surface mount electronic components placed on the solder paste deposits. The board 50 is conveyed through the reflow oven 10 in the direction 11A toward the exit 10B of the tunnel 15.

At stage 120, the conveyor means 11 conveys the board 50 past one or more sensor devices 60 that detect the board and can relay information to a coupled processor, e.g., disposed locally or remotely to the reflow oven 10.

At stage 125, the conveyor means 11 conveys the board 50 through the heating zone 16, where the board and its components and solder paste are heated to the required temperatures to cause the solder paste to flow.

At stage 130, the exhaust station 20 exhausts hot gases from the oven 10.

At stage 140, the processor 56 coupled to the one or more sensor devices 60 determines if the board 50 has reached or is proximate to the evaporative cooling zone 17, and/or the apparatus 27, based on at least a function of the speed of the conveyor means 11, a size of the board 50, one or more temperatures of the heating zone 16, and/or an elapsed time, e.g., determined by a delay timer.

At stage 150, once the processor 56 determines the board 50 has reached or is proximate to the zone 17, and/or the apparatus 27, one or more of the spraying assemblies 32 and 34 is actuated, e.g., receives water, pressurized water and/or pressurized gas, and the spray nozzles 42, 43, and 44 produce water spray mist as a pressurized and/or atomized water mist to contact the board 50.

At stage 160, the conveyor means 11 conveys the board 50 through the cooling zone 18 in which one or more cooling fans 22 blows cooling air onto the board 50.

At stage 170, the board 50 exits the tunnel 15 via the exit 10A and is recovered from the oven 10 at 25.

Having thus described at least one illustrative embodiment of the invention, various alterations, modifications and improvements will readily occur to those skilled in the art. Such alterations, modifications and improvements are intended to be within the scope and spirit of the invention. For instance, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for cooling printed circuit boards during a reflow soldering process performed in a reflow oven comprising:
a water mist cooling apparatus including:
a) a water distribution manifold assembly; and
b) at least one spray nozzle including a first inlet connected to the manifold and a nozzle outlet configured and angled to delivery atomized water to the printed circuit boards.

2. The system of claim 1, wherein the at least one spray nozzle is angled to direct atomized water at the printed circuit boards as the boards exit a heating zone of the reflow oven.

3. The system of claim 2, wherein the atomized water cools the printed circuit boards through at least evaporative cooling.

4. The system of claim 1, further comprising at least one sensor device disposed and configured to sense entrance and movement of the printed circuit boards into and through the reflow oven.

5. The system of claim 4, further comprising at least one processor operatively coupled to the at least one sensor device and configured to:
sense the printed circuit boards entering the reflow oven; and
implement a delay timer as a function of a speed of the printed circuit boards to control an actuation time and a deactuation time of the at least one spray nozzle.

6. The system of claim 5, wherein the at least one processor is further configured to control the at least one spray nozzle as a function of at least one of a size of the printed circuit boards entering the reflow oven and a location of one or more components on the printed circuit boards.

7. The system of claim 5, wherein the at least one processor is further configured to control the at least one spray nozzle as a function of a temperature of a heating zone of the reflow oven.

8. The system of claim 1, wherein the system is further configured for use during a reflow lead-free soldering process.

9. A reflow oven for reflow soldering surface mount electronic components to printed circuit boards, the reflow oven comprising:
conveying means for conveying printed circuit boards through one or more zones of the reflow oven;
a heating zone;
a cooling zone; and
an evaporative cooling zone located between the heating zone and the cooling zone, the evaporative cooling zone comprising:
a) a water distribution manifold assembly,
b) at least one spray nozzle including a first inlet connected to the manifold and a spray outlet configured and angled to delivery atomized water to the printed circuit boards.

10. The reflow oven of claim 9, wherein the at least one spray nozzle is angled to aim atomized water at the printed circuit boards as the boards exit the heating zone.

11. The reflow oven of claim 10, wherein the atomized spray cools the printed circuit boards through at least evaporative cooling.

12. The reflow oven of claim 8, further comprising at least one sensor device configured to sense the printed circuit boards as the boards enter the reflow oven.

13. The reflow oven of claim 12, further comprising at least one processor coupled to the at least one sensor device and configured to:
sense the printed circuit boards as the boards enter the reflow oven; and
implement a delay timer as a function of a speed of conveying means conveying the printed circuit boards through the reflow oven to control an actuation time and a deactuation time of the at least one spray nozzle.

14. The system of claim 13, wherein the at least one processor is further configured to control the at least one spray nozzle as a function of at least one of a size of the printed circuit boards entering the reflow oven and a location of one or more components on the printed circuit boards.

15. The reflow oven of claim 13, wherein the at least one processor is further configured to control the at least one spray nozzle as a function of a temperature of the heating zone of the reflow oven.

16. The reflow oven of claim 8, wherein the water distribution manifold assembly further comprises an inlet water connection configured to receive at least one of water and pressurized water.

17. The reflow oven of claim 16, wherein the water mist cooling apparatus further comprises a water pressure regulator with an inlet connected to the inlet water connection and an outlet coupled to the water distribution manifold assembly.

18. The reflow oven of claim 18, further comprising a water holding tank and a water pump disposed and configured to receive water from the water tank and to supply pressurized water to the water distribution manifold assembly.

19-22. (canceled)

23. A reflow oven for reflow soldering surface mount electronic components to printed circuit boards, the reflow oven comprising:
conveying means for conveying printed circuit boards through one or more zones of the reflow oven;
a heating zone;
a cooling zone; and
cooling means for rapidly cooling the printed circuit boards through evaporative cooling after the printed circuit boards exit the heating zone and before the printed circuit boards enter the cooling zone.

24. The system of claim 1, further comprising a second inlet connected to the at least one spray nozzle, the second inlet being configured for connection to a pressurized gas supply and being further configured to deliver gas to the at least one nozzle, wherein gas supplied to the at least one nozzle atomizes water at the nozzle outlet.

25. The reflow oven of claim 9, further comprising a second inlet connected to the at least one spray nozzle, the second inlet being configured for connection to a pressurized gas supply and being further configured to deliver gas to the at least one nozzle, wherein gas supplied to the at least one nozzle atomizes water at the nozzle outlet.
